(19) United States
(12) Patent Application Publication
(10) Pub. No.: US 2011/0179837 A1
(43) Pub. Date: Jul. 28, 2011

(54) AUTOMATIC BIKE LOCKING CHARGING MACHINE

(76) Inventor: Hung-Ju CHEN, Taichung City (TW)

(21) Appl. No.: 12/783,000

(22) Filed: May 19, 2010

(30) Foreign Application Priority Data
Jan. 22, 2010 (TW) 099201376

(51) Int. Cl. E05B 71/00

(52) U.S. Cl. 70/233

(57) ABSTRACT

An automatic bike locking charging machine is provided. By operating a control member and a slot of a panel, a control circuit board drives a control unit to open or close a swing rod connected with a rotary rod of a decelerating device with respect to a casing, such that the frame of a bike is restrained between a hooking rod of the casing and the swing rod of the rotary rod of the decelerating device to park the bike and to provide an anti-theft function.

### BACKGROUND OF THE INVENTION

1. Field of the Invention

The present invention relates to an automatic bike locking charging machine, and more particularly to a parking charging device for bikes.

2. Description of the Prior Art

As shown in FIG. 10, a conventional bike parking device comprises two lateral frames (50) and a plurality of longitudinal positioning frames (60). The longitudinal positioning frames (60) are aligned and connected between the two lateral frames (50). A wheel (41) of a bike (40) is positioned between two adjacent longitudinal positioning frames (60) connected to the lateral frames (50), so that bikes can be aligned and parked with respect to the lateral frames (50). The conventional bike parking device has the following shortcomings:
1. Insufficient functions: the wheel of the bike is positioned between two adjacent longitudinal positioning frames connected to the lateral frames and the bikes are aligned and parked with respect to the lateral frames, without anti-theft or other auxiliary functions.
2. Bad anti-theft: the wheel of the bike is positioned between two adjacent longitudinal positioning frames connected to the lateral frames, which provides a bad anti-theft.

Accordingly, the inventor of the present invention has devoted himself based on his many years of practical experiences to improve the aforesaid problems of the conventional bike parking device.

### SUMMARY OF THE INVENTION

The primary object of the present invention is to provide an automatic bike locking charging machine. Control units are accommodated in a chamber of a casing. A swing rod connected with a rotary rod of a decelerating device passes through an opening of the casing. A panel is connected to a front side of the chamber of the casing. A control circuit board of the panel is electrically connected to a control unit. By operating a control member and a slot of the panel, the control circuit board drives the control unit to open or close the swing rod of the rotary rod of the decelerating device with respect to the casing, such that the frame of a bike is restrained between the hooking rod of the casing and the swing rod of the rotary rod of the decelerating device to park the bike and to provide an anti-theft function.

### BRIEF DESCRIPTION OF THE DRAWINGS

FIG. 1 is a perspective view of the present invention;

FIG. 2 is an exploded view of the present invention;

FIG. 3 is a partially side cross-sectional view of the present invention;

FIG. 4 is a front view of the present invention when in use;

FIG. 5 is a side view of the present invention when in use;

FIG. 6 shows a first embodiment of the present invention provided with a motor, a decelerating belt pulley or a decelerating chain gear device;

FIG. 7 is a perspective view of a second embodiment of the present invention showing that the hooking rods and the swing rods are located at a lower position;

FIG. 8 is a schematic view showing the second embodiment of the present invention when in use;

FIG. 9 shows a third embodiment of the present invention provided with a sensor, and

FIG. 10 is a schematic view showing a conventional bike parking device.

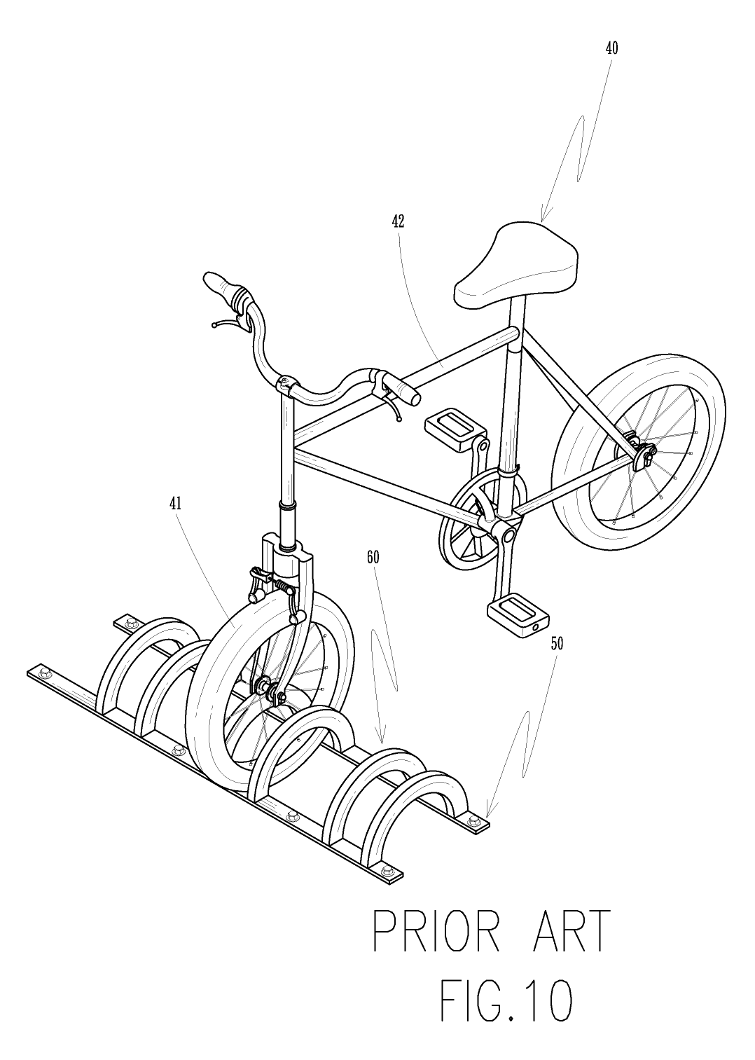

### DETAILED DESCRIPTION OF THE PREFERRED EMBODIMENTS

Embodiments of the present invention will now be described, by way of example only, with reference to the accompanying drawings.

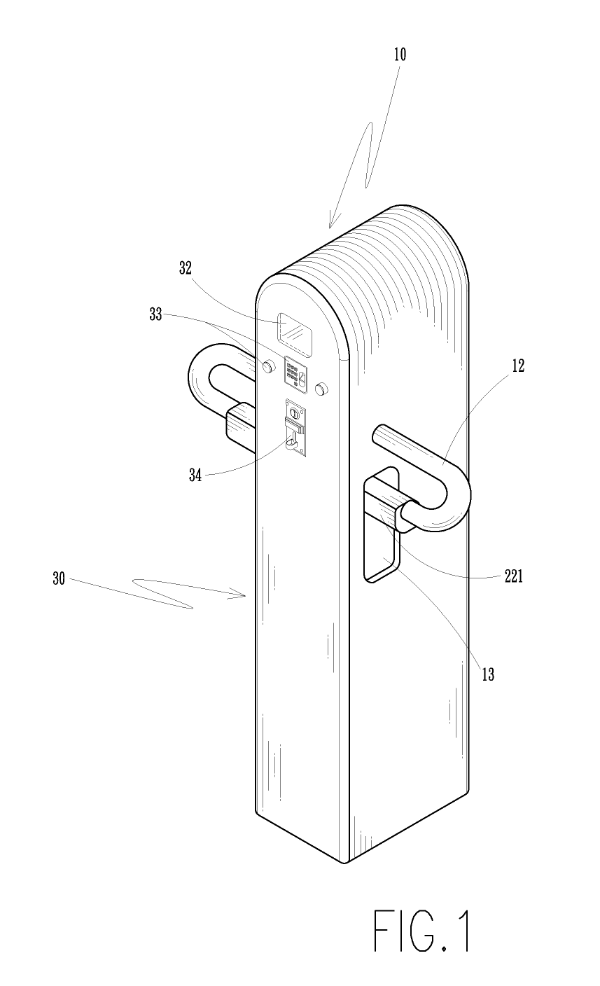

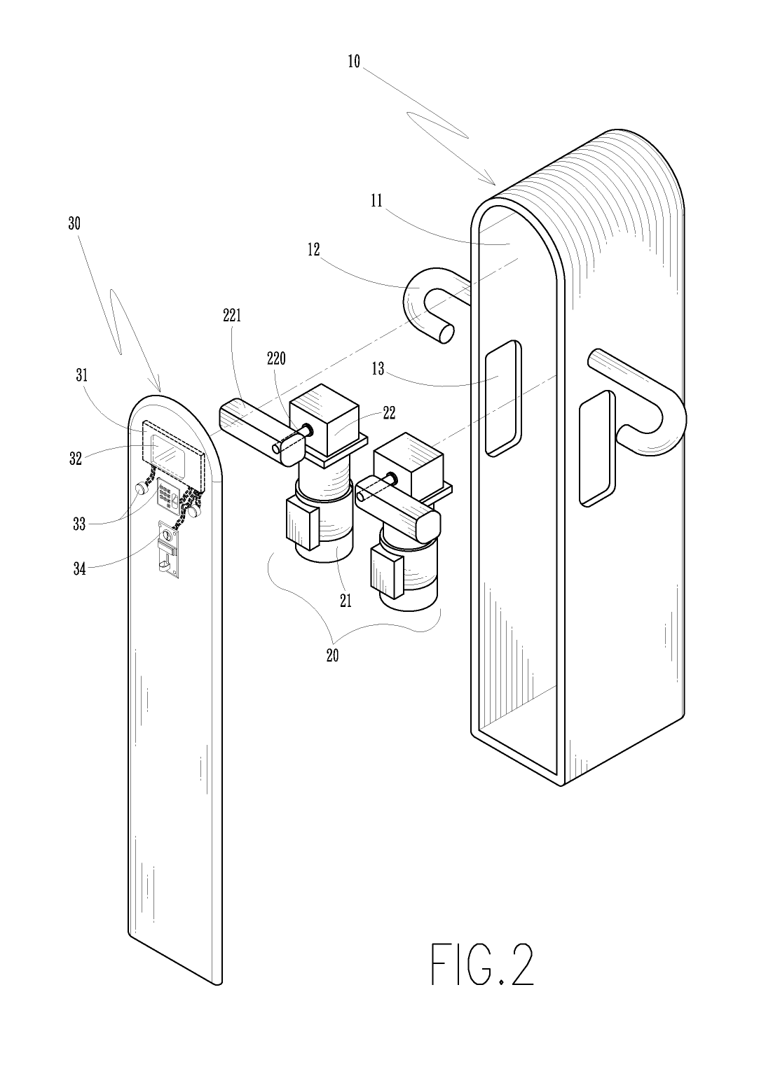

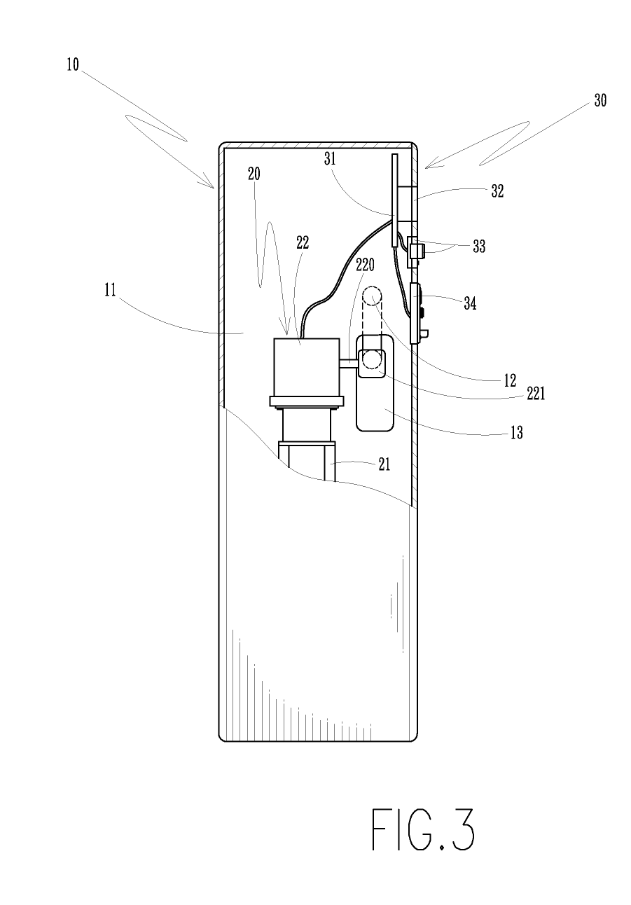

FIG. 1 is a perspective view of the present invention. FIG. 2 is an exploded view of the present invention. FIG. 3 is a partially cross-sectional view of the present invention. The automatic bike locking charging machine of the present invention comprises a casing (10), a plurality of control units (20) and a panel (30).

The casing (10) comprises a chamber (11), a pair of hooking rods (12) at two opposite sides of the casing (10), and a pair of openings (13) disposed under the pair of hooking rods (12).

Each control unit (20) comprises a driving device (21) which is connected with a decelerating device (22). The decelerating device (22) comprises a rotary rod (220) which is connected with a swing rod (221). The control units (20) are accommodated in the chamber (11) of the casing (10). The swing rod (221) connected with the rotary rod (220) of the decelerating device (22) passes through the opening (13) of the casing (10). The driving device (21) is a motor. The decelerating device (22) is a reduction gear.

The panel (30) comprises a control circuit board (31). The control circuit board (31) is electrically connected with a display member (32), a control member (33), and a slot (34). The panel (30) is connected to a front side of the chamber (11) of the casing (10). The control circuit board (31) of the panel (30) is electrically connected to the control unit (20). The assembly of the automated bike locking charging machine of the present invention is completed.

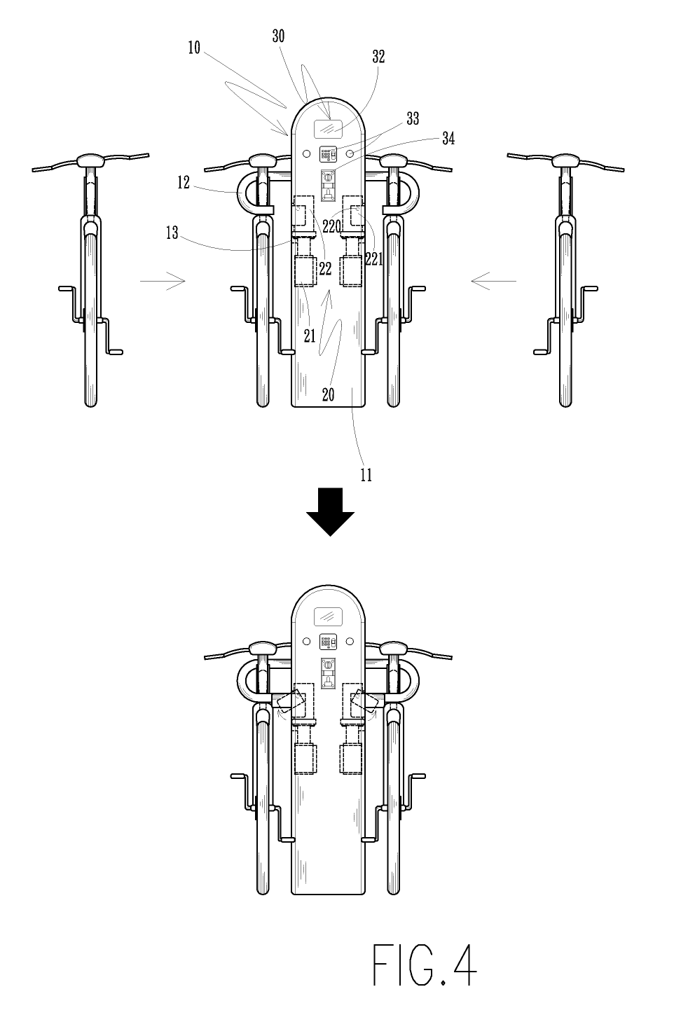

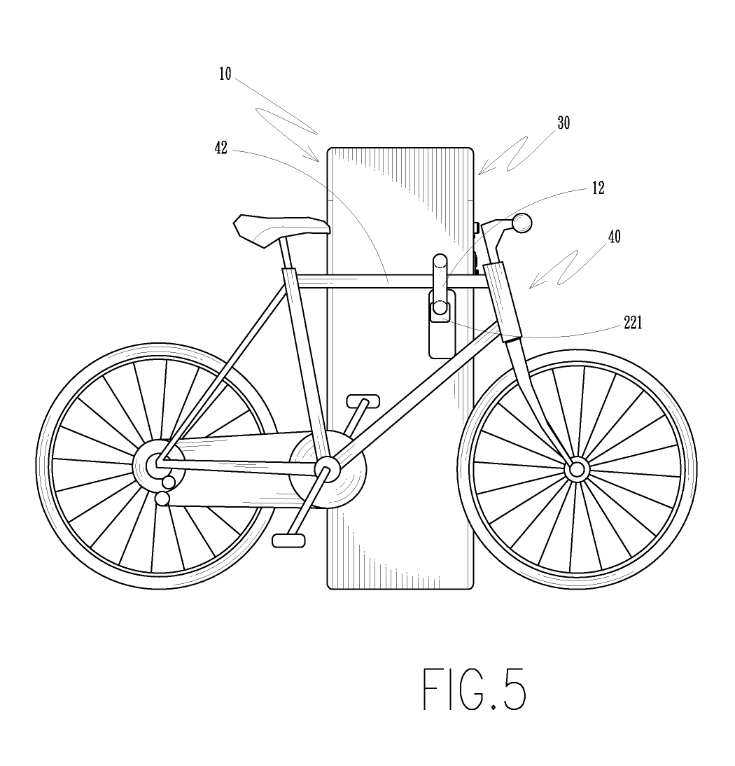

FIG. 4 is a front view of the automated bike locking charging machine of the present invention when in use. FIG. 5 is a side view of the automated bike locking charging machine of the present invention when in use. The control units (20) are accommodated in the chamber (11) of the casing (10). The swing rod (221) connected with the rotary rod (220) of the decelerating device (22) passes through the opening (13) of the casing (10). The panel (30) is connected to the front side of the chamber (11) of the casing (10). The control circuit board (31) of the panel (30) is electrically connected to the control unit (20), as shown in FIG. 3. By operating the control member (33) and the slot (34) of the panel (30), the control circuit board (31) drives the control unit (20) to open or close the swing rod (221) of the rotary rod (220) of the decelerating device (22) with respect to the casing (10), such that the frame (42) of the bike (40) is restrained between the hooking rod (12) of the casing (10) and the swing rod (221) of the rotary rod (220) of the decelerating device (22) to park the bike (40) and to provide an anti-theft function.

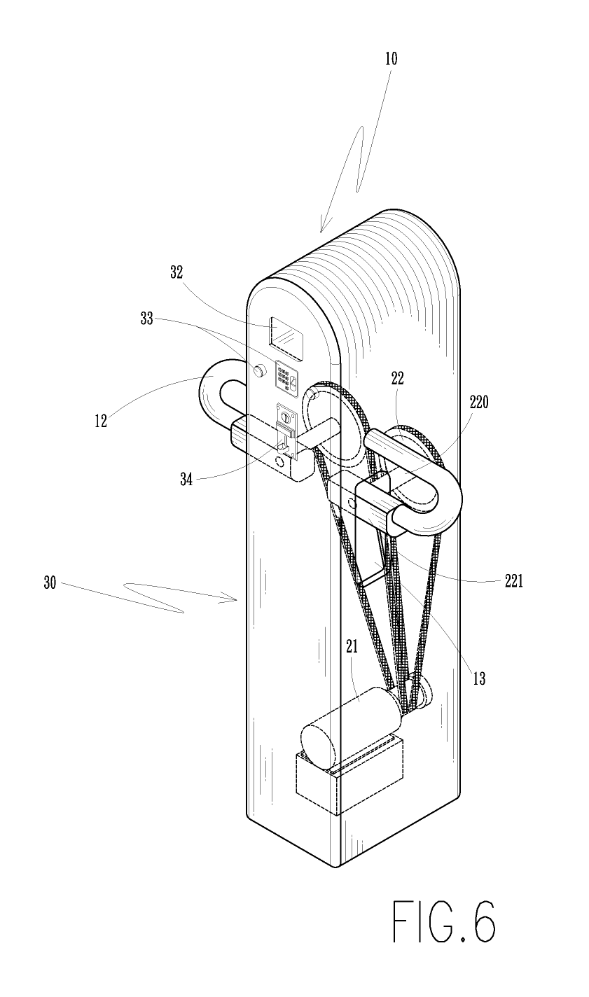

FIG. 6 shows a first embodiment of the automatic bike locking charging machine of the present invention provided with a motor, a decelerating belt pulley, a decelerating chain gear device, which is substantially similar to the structure as shown in FIG. 1 to FIG. 3 with the exceptions described hereinafter. The driving device (21) drives the decelerating belt pulley and the decelerating chain gear, and then the rotary rod (220) of the decelerating device (22) drives the swing rod (221).

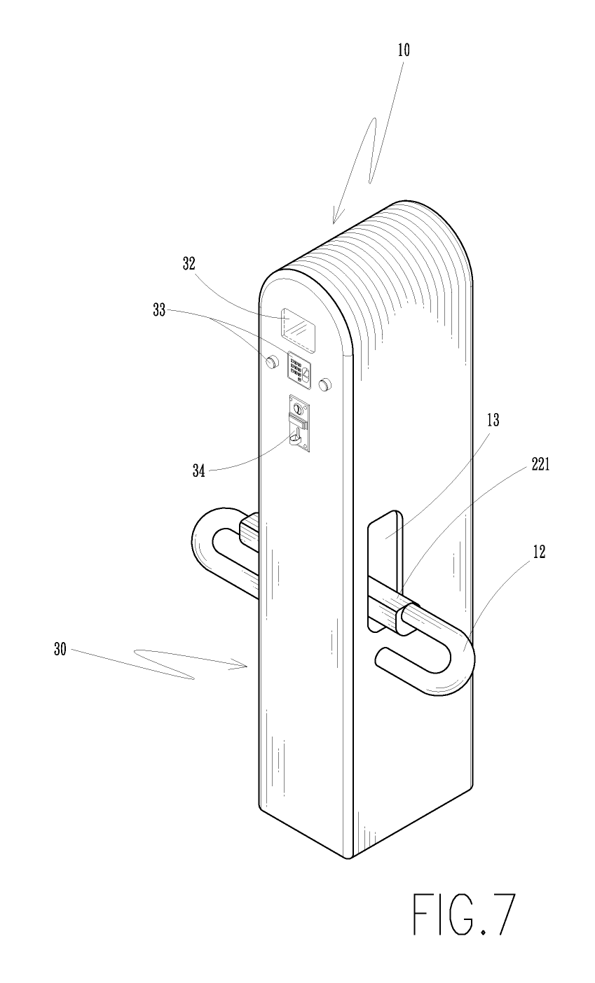

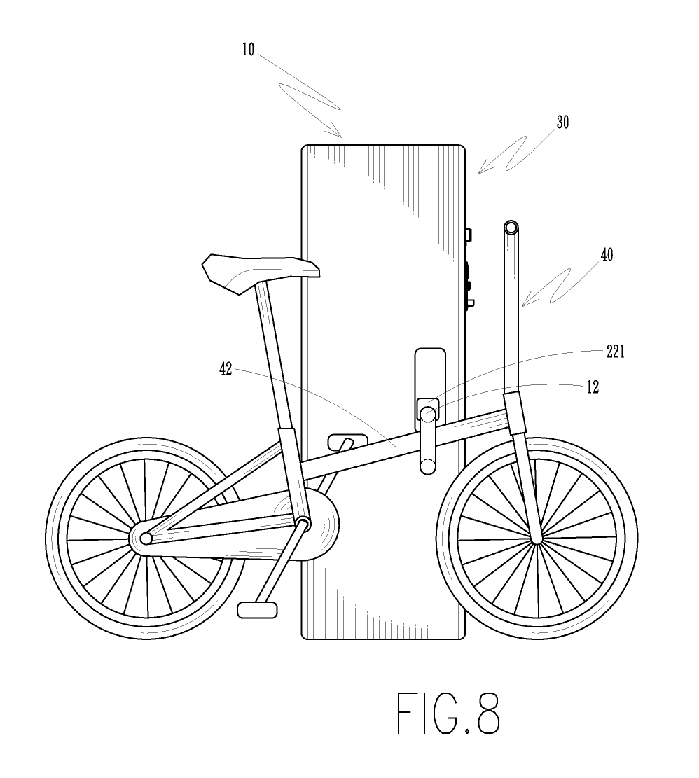

FIG. 7 is a perspective view of a second embodiment of the automatic bike locking charging machine of the present invention. FIG. 8 is a schematic view showing the second embodiment of the automatic bike locking charging machine of the present invention when in use. The second embodiment is substantially similar to the structure as shown in FIG. 1 to FIG. 3 except that the hooking rods and the swing rods are located at a lower position. The pair of hooking rods (11) is located at a lower section of the casing (10) and the pair of openings (13) is located above the pair hooking rods (11), such that a lower bike (40) or a collapsible bike can be locked by the present invention.

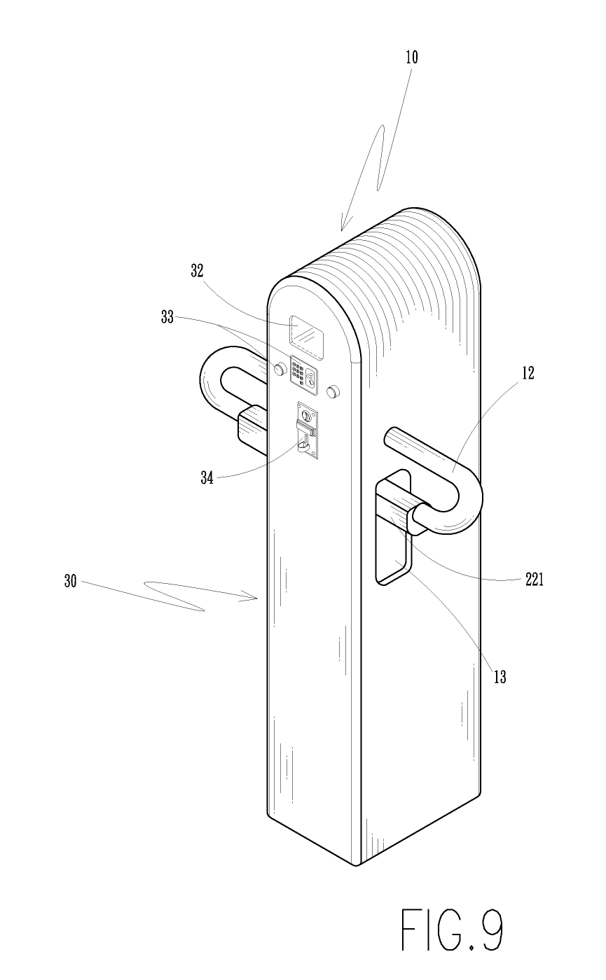

FIG. 9 shows a third embodiment of the automatic bike locking charging machine of the present invention provided with a sensor, which is substantially similar to the structure as shown in FIG. 1 to FIG. 3 with the exceptions described hereinafter. The control member (33) of the panel (30) is provided with a card sensor or a fingerprint recognition device. The control circuit board (31) comprises a control chip which counts the charge by time, by frequency, free, by a card on line or the like. The card sensor or the fingerprint recognition device of the control member (33) is electrically connected with the control chip of the control circuit board (31) to count the charge by time, by frequency, free, by the card on line or the like. By the aforesaid structure, the operation function can be enhanced, increasing the practicability of the present invention.

The advantages of the present invention are as follows:
1. Better function: by operating the control member and the slot of the panel, the control circuit board drives the control unit, and the control circuit board has the control chip to count the charge by time, by frequency, free, by card on line or the like, providing multiple use function.
2. Better anti-theft: By operating the control member and the slot of the panel, the control circuit board drives the control unit to open or close the swing rod of the rotary rod of the decelerating device with respect to the casing, such that the frame of the bike is restrained between the hooking rod of the casing and the swing rod of the rotary rod of the decelerating device, providing an anti-theft function.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An automatic bike locking charging machine, comprising:
a casing, the casing comprising a chamber, a pair of hooking rods and a pair of openings at two opposite sides of the casing;
a plurality of control units, each of the control units comprising a driving device which is connected with a decelerating device, the decelerating device comprising a rotary rod which is connected with a swing rod, the control units being accommodated in the chamber of the casing, the swing rod connected with the rotary rod of the decelerating device passing through the opening of the casing; and
a panel, the panel comprising a control circuit board, the control circuit board being electrically connected with a display member, a control member and a slot, the panel being connected to a front side of the chamber of the casing, the control circuit board of the panel being electrically connected to the control units.

2. The automatic bike locking charging machine as claimed in claim 1, wherein the pair of openings is located under the pair of hooking rods.

3. The automatic bike locking charging machine as claimed in claim 1, wherein the pair of openings is located above the pair of hooking rods.

4. The automatic bike locking charging machine as claimed in claim 1, wherein the driving device of the control unit is a motor.

5. The automatic bike locking charging machine as claimed in claim 1, wherein the decelerating device of the control unit is a reduction gear.

6. The automatic bike locking charging machine as claimed in claim 1, wherein the decelerating device of the control unit is a decelerating belt pulley.

7. The automatic bike locking charging machine as claimed in claim 1, wherein the decelerating device of the control unit is a decelerating chain gear.

8. The automatic bike locking charging machine as claimed in claim 1, wherein the control member of the panel is provided with a card sensor or a fingerprint recognition device, the control circuit board comprises a control chip which counts the charge by time, by frequency, free, or by a card on line, the card sensor or the fingerprint recognition device of the control member is electrically connected with the control chip of the control circuit board to count the charge by time, by frequency, free, or by the card on line.
